(19) United States
(12) Patent Application Publication
(10) Pub. No.: US 2024/0324006 A1
(43) Pub. Date: Sep. 26, 2024

(54) BASE STATION AND COMMUNICATION METHOD

(71) Applicant: NTT DOCOMO, INC., Tokyo (JP)

(72) Inventors: Naoya Shibaike, Chiyoda-ku, Tokyo (JP); Hiroki Harada, Chiyoda-ku, Tokyo (JP); Satoshi Nagata, Chiyoda-ku, Tokyo (JP); Qiping Pi, Haidian District, Beijing (CN); Jing Wang, Haidian District, Beijing (CN); Lan Chen, Haidian District, Beijing (CN)

(73) Assignee: NTT DOCOMO, INC., Tokyo (JP)

(21) Appl. No.: 18/577,170

(22) PCT Filed: Jul. 28, 2021
(86) PCT No.: PCT/JP2021/027981

§ 371 Date: Jan. 5, 2024

(51) Int. Cl. H04W 74/0808

(52) U.S. Cl. CPC H04W 74/0808

(57) ABSTRACT

A base station includes: a reception unit configured to perform time division multiplexing of a plurality of reception beams corresponding to a plurality of transmission beams applied for transmission in COT (Channel Occupancy Time), and to perform LBT (Listen before talk) in which sensing is performed by applying each of the plurality of reception beams using a round robin method; and a transmission unit configured to apply, to the transmission in the COT, a transmission beam corresponding to a reception beam, among the plurality of the reception beams, for which a busy state is not detected in the LBT.

### FIELD OF THE INVENTION

The present invention relates to a base station and a communication method in a wireless communication system.

### BACKGROUND OF THE INVENTION

Regarding NR (New Radio) (also referred to as “5G”), or a successor system to LTE (Long Term Evolution), technologies have been discussed which satisfy the following requirements: a high capacity system, high data transmission rate, low delay, simultaneous connection of multiple terminals, low cost, power saving, etc. (for example, Non-Patent Document 1).

NR release 17 discusses using a higher frequency band than a conventional release (e.g., Non-Patent Document 2). For example, applicable numerologies including subcarrier spacings, channel bandwidths, etc., physical layer design, and possible failures in actual wireless communication in the 52.6 GHz to 71 GHz frequency band have been discussed.

### CITATION LIST

### Non-Patent Document

Non-Patent Document 1: 3GPP TS 38.300 V16.6.0 (2021-06)
Non-Patent Document 2: 3GPP TS 38.306 V16.5.0 (2021-06)

### SUMMARY OF THE INVENTION

### Technical Problem

Directional LBT (Directional Listen before talk) in which beams are applied to sensing in a frequency band that is newly operated and uses a frequency higher than a conventional frequency has been discussed. In a case where directional LBT is performed, it is necessary to determine how to apply beams to sensing.

The present invention has been made in view of the above points, and it is possible to determine a beam to be applied to a directional LBT (Directional Listen before talk) in a radio communication system.

### Solution to Problem

According to the disclosed technique, a base station is provided. The base station includes: a reception unit configured to perform time division multiplexing of a plurality of reception beams corresponding to a plurality of transmission beams applied for transmission in COT (Channel Occupancy Time), and to perform LBT (Listen before talk) in which sensing is performed by applying each of the plurality of reception beams; and a transmission unit configured to apply, to the transmission in the COT, a transmission beam corresponding to a reception beam, among the plurality of the reception beams, for which a busy state is not detected in the LBT.

### Advantageous Effects of Invention

According to the disclosed technique, it is possible to determine a beam to be applied to directional LBT (Directional Listen before talk) in a radio communication system.

### BRIEF DESCRIPTION OF THE DRAWINGS

FIG. 1 is a drawing illustrating a configuration example of a wireless communication system according to an embodiment of the present invention.

FIG. 2 is a drawing illustrating an example of a frequency range according to an embodiment of the present invention.

FIG. 3 is a drawing illustrating LBT.

FIG. 4 is a drawing illustrating an example of an issue of a hidden terminal.

FIG. 5 is a diagram illustrating an example (1) of eCCA in an embodiment of the present invention.

FIG. 6 is a diagram illustrating an example (2) of eCCA in an embodiment of the present invention.

FIG. 7 is a drawing illustrating an example (1) of LBT in an embodiment of the present invention.

FIG. 8 is a drawing illustrating an example (2) of LBT in an embodiment of the present invention.

FIG. 9 is a drawing illustrating an example (3) of LBT in an embodiment of the present invention.

FIG. 10 is a drawing illustrating an example (4) of LBT in an embodiment of the present invention.

FIG. 11 is a drawing illustrating an example (5) of LBT in an embodiment of the present invention.

FIG. 12 is a drawing illustrating an example (6) of LBT in an embodiment of the present invention.

FIG. 13 is a drawing illustrating an example (7) of LBT in an embodiment of the present invention.

FIG. 14 is a drawing illustrating an example (8) of LBT in an embodiment of the present invention.

FIG. 15 is a drawing illustrating an example (9) of LBT in an embodiment of the present invention.

FIG. 16 is a drawing illustrating an example (10) of LBT in an embodiment of the present invention.

FIG. 17 is a drawing illustrating an example (11) of LBT in an embodiment of the present invention.

FIG. 18 is a drawing illustrating an example (12) of LBT in an embodiment of the present invention.

FIG. 19 is a drawing illustrating an example (13) of LBT in an embodiment of the present invention.

FIG. 20 is a drawing illustrating an example (14) of LBT in an embodiment of the present invention.

FIG. 21 is a drawing illustrating an example (15) of LBT in an embodiment of the present invention.

FIG. 22 is a drawing illustrating an example (16) of LBT in an embodiment of the present invention.

FIG. 23 is a drawing illustrating an example (17) of LBT in an embodiment of the present invention.

FIG. 24 is a drawing illustrating an example (18) of LBT in an embodiment of the present invention. [FIG. 25] FIG. 25 is a drawing illustrating an example of a functional structure of a base station 10 in an embodiment of the present invention.

FIG. 26 is a drawing illustrating an example of a functional structure of a terminal 20 in an embodiment of the present invention.

FIG. 27 is a drawing illustrating an example of a hardware structure of the base station 10 or the terminal 20 in an embodiment of the present invention.

### DETAILED DESCRIPTION OF THE PREFERRED EMBODIMENTS

In the following, referring to the drawings, one or more embodiments of the present invention will be described. It should be noted that the embodiments described below are examples. Embodiments of the present invention are not limited to the following embodiments.

In operations of a wireless communication system according to an embodiment of the present invention, conventional techniques will be used appropriately. With respect to the above, for example, the conventional techniques are related to, but not limited to, the existing LTE. Further, it is assumed that the term “LTE” used in the present specification has, unless otherwise specifically mentioned, a broad meaning including a scheme of LTE-Advanced and a scheme after LTE-Advanced (e.g., NR).

Furthermore, in one or more embodiments described below, terms that are used in the existing LTE are used, such as SS (Synchronization signal), PSS (Primary SS), SSS (Secondary SS), PBCH (Physical broadcast channel), PRACH (Physical random access channel), PDCCH (Physical Downlink Control Channel), PDSCH (Physical Downlink Shared Channel), PUCCH (Physical Uplink Control Channel), PUSCH (Physical Uplink Shared Channel), etc. The above-described terms are used for the sake of description convenience. Signals, functions, etc., which are similar to the above-described terms, may be referred to as different names. Further, terms, which are used in NR and correspond to the above-described terms, are NR-SS, NR-PSS, NR-SSS, NR-PBCH, NR-PRACH, etc. However, even when a signal is used for NR, there may be a case in which the signal is not referred to as “NR-”.

In addition, in an embodiment of the present invention, the duplex method may be a TDD (Time Division Duplex) method, an FDD (Frequency Division Duplex) method, or any other method (e.g., Flexible Duplex, or the like).

Further, in an embodiment of the present invention, the expression, radio (wireless) parameters are “configured (set)” may mean that a predetermined value is pre-configured, or may mean that a radio parameter indicated by the base station 10 or the terminal 20 is configured.

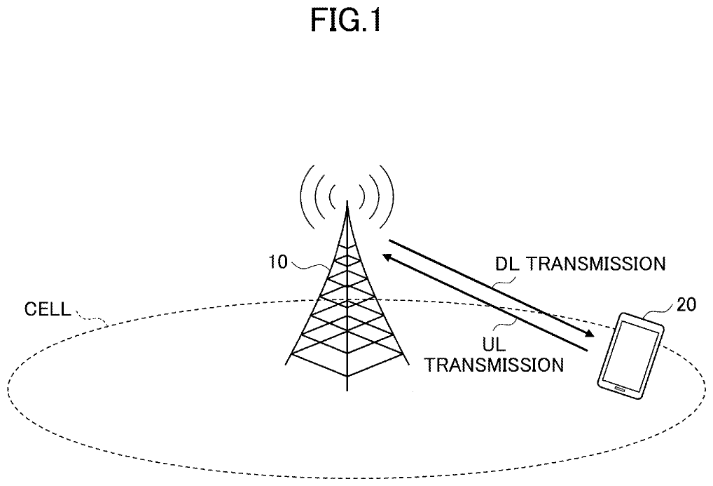

FIG. 1 is a drawing illustrating a configuration example of a wireless communication system according to an embodiment of the present invention. As illustrated in FIG. 1, a wireless communication system according to an embodiment of the present invention includes a base station 10 and a terminal 20. In FIG. 1, a single base station 10 and a single terminal 20 are illustrated as an example. There may be a plurality of base stations 10 and a plurality of terminals 20.

The base station 10 is a communication device that provides one or more cells and performs wireless communications with the terminal 20. Physical resources of radio signals may be defined in the time domain and the frequency domain, the time domain may be defined by the number of OFDM (Orthogonal Frequency Division Multiplexing) symbols, and the frequency domain may be defined by the number of sub-carriers or resource blocks. The base station 10 transmits a synchronization signal and system information to the terminal 20. The synchronization signal is, for example, an NR-PSS and an NR-SSS. The system information is transmitted via, for example, a NR-PBCH, and may be referred to as broadcast information. The synchronization signal and the system information may be referred to as an SSB (SS/PBCH block). As shown in FIG. 1, the base station 10 transmits a control signal or data in DL (Downlink) to the terminal 20 and receives a control signal or data in UL (Uplink) from the terminal 20. The base station 10 and terminal 20 are capable of transmitting and receiving a signal by performing the beamforming. Further, the base station 10 and the terminal 20 can both apply MIMO (Multiple Input Multiple Output) communication to DL or UL. Further, the base station 10 and the terminal 20 may both perform communications via a secondary cell (SCell: Secondary Cell) and a primary cell (PCell: Primary Cell) using CA (Carrier Aggregation). In addition, the terminal 20 may perform communications via a primary cell of the base station 10 and a primary secondary cell group cell (PSCell: Primary SCG Cell) of another base station 10 using DC (Dual Connectivity).

The terminal 20 may be a communication apparatus that includes a wireless communication function such as a smart-phone, a mobile phone, a tablet, a wearable terminal, a communication module for M2M (Machine-to-Machine), or the like. As shown in FIG. 1, the terminal 20 uses various communication services provided by the wireless communication system by receiving control signals or data in DL from the base station 10 and transmitting control signals or data in UL to the base station 10. In addition, the terminal 20 receives various reference signals transmitted from the base station 10 and performs measurement of the propagation path quality based on the reception result of the reference signals.

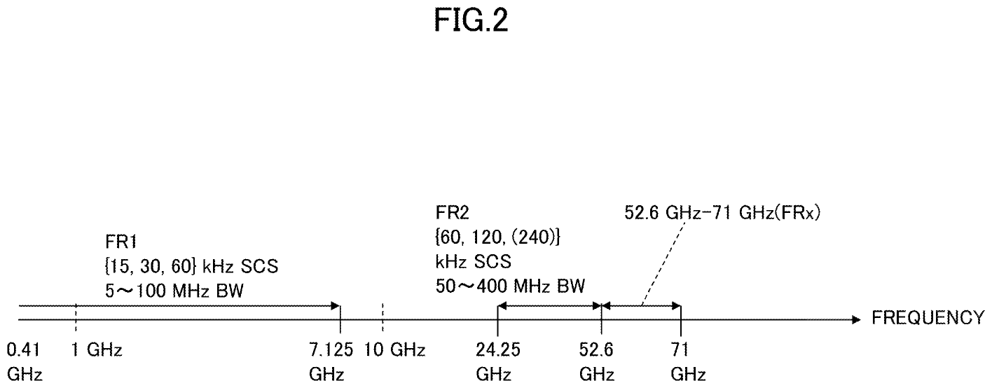

FIG. 2 is a drawing illustrating an example of a frequency range according to an embodiment of the present invention. In the NR specifications of 3GPP Release 15 and Release 16, for example, an operation in a frequency band of 52.6 GHz or more has been discussed. Note that, as shown in FIG. 2, FR (Frequency range) 1 in which current operation is defined is a frequency band from 410 MHz to 7.125 GHz, SCS (Sub carrier spacing) is 15, 30 or 60 kHz, and bandwidth is from 5 MHz to 100 MHz. FR2 is a frequency band from 24.25 GHz to 52.6 GHz, SCS is 60, 120 or 240 kHz, and bandwidth is from 50 MHz to 400 MHz. For example, the newly operated frequency band may be assumed to be from 52.6 GHz to 71 GHz. Furthermore, a frequency band beyond 71 GHz may be assumed to be supported.

In the above new frequency bands operated in 3GPP release 17, the channel access mechanism is assumed to be beam-based in order to comply with the regulatory requirements that are applied to the unlicensed bands. For example, both LBT (Listen before talk) based access and non-LBT based access may be employed, and in the case of non-LBT based access, no additional sensing mechanism may be employed. In addition, omni-directional LBT, directional LBT, and receiver side assistance may be employed. In addition, enhancements related to the power detection threshold may be performed. Hereafter, the omni-directional LBT may be referred to as omni LBT.

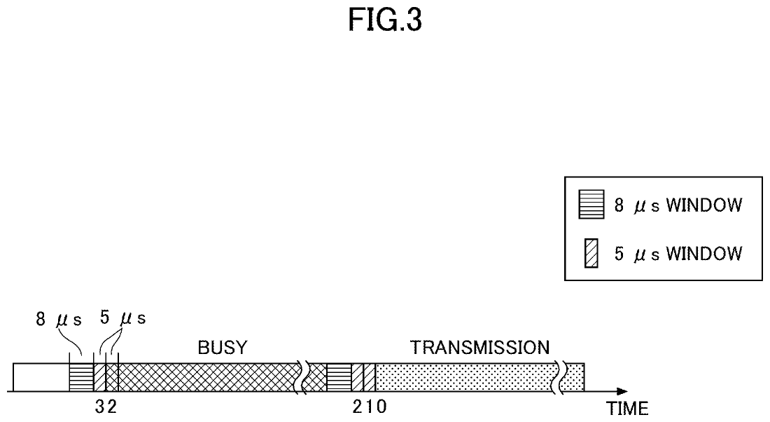

FIG. 3 is a drawing illustrating an example of LBT. For example, in the frequency band from 52.6 GHz to 71 GHz, the CCA (Clear Channel Assessment) procedure may define a period of 8 microseconds+5 microseconds+random counter as a detection period of a channel, as shown in FIG. 3. FIG. 3 illustrates an example in which the random counter is 3 in the first LBT, 8+5×3=23 microseconds is the channel detection period, and the channel busy is detected in the detection period from 14 microseconds to 18 microseconds.

Further, FIG. 3 illustrates an example in which the second LBT is started from a state in which the random counter is 2 when channel busy is detected in the first LBT, 8+5×2=18 microseconds is the channel detection period, and transmission is started because channel busy is not detected in the detection period.

Note that COT (Channel Occupancy Time) sharing may be supported or need not be supported. In addition, LBT that applies a backoff and a random counter may be performed by other terminals within one COT, which may be the same as that at the start of the CCA procedure. In addition, LBT that does not apply a backoff and a random counter may be performed by other terminals within one COT, which may be the same as type 2 LBT in NR-U. In addition, LBT need not be performed by other terminals within one COT.

Because beam-based transmission and reception are widely used at NR 52.6-71 GHz, the directional LBT that applies beams to sensing may be supported to improve LBT success rate. Hereinafter, the directional LBT may be simply referred to as an LBT.

For example, an LBT corresponding to a COT that applies multiple beams of MU-MIMO (Multi User MIMO) or SDM (Spatial Division Multiplexing) transmission may be supported. For example, the COT that applies multiple beams may be acquired by a single LBT using a wide sensing beam, or may be acquired by an LBT for each beam. It should be noted that the sensing beam is a beam that is applied to sensing in an LBT, and may be referred to as an eCCA (enhanced CCA) beam. In addition, successful LBT or successful eCCA may mean that a busy state is not detected as a result of performing sensing by applying a beam, and failed LBT or failed eCCA may mean that a busy state is detected as a result of performing sensing by applying a beam.

In addition, within a COT to which a time division multiplex beam is applied by beam switching: a single LBT to which a wide beam covering all beams used in the COT is applied may be performed according to an appropriate power detection threshold; independent LBT sensing may be performed for each of the beams used in the COT at the start of the COT; or independent LBT sensing may be performed for each of the beams used in the COT at the start of the COT by adding requirements of category 2 LBT. Note that the category 2 LBT may be an LBT without a random backoff.

Note that applying a beam in LBT may mean applying a reception beam or applying reception beamforming. LBT that applies a reception beam or reception beamforming corresponding to a transmission beam or transmission beamforming applied to transmission in COT, may be performed. Transmission may be performed by applying, in the COT, the transmission beam or transmission beamforming corresponding to the successful reception beam or successful reception beamforming in the LBT sensing. Note that a beam: that is wider than other beams; that covers other beams; or that includes other beams, may be defined as a beam that covers at least spatial directions of the other beams, or may be defined differently.

In addition, when LBT sensing for each beam is performed during MU-MIMO transmission, the following operations 1) to 4) may be performed.

1) In a case where LBT for each beam is performed according to time division multiplexing, after an eCCA for a certain beam is completed, an eCCA for another beam is performed, and transmission is not performed between the eCCAs.
2) In a case where LBT for each beam is performed according to time division multiplexing, after an eCCA for a certain beam is completed, transmission to which the beam is applied is performed in COT. Thereafter, an eCCA for another beam is performed.
3) In a case where LBT for each beam is performed according to time division multiplexing, eCCAs of different beams may be simultaneously performed by using a round-robin method
4) In a case where LBTs for different beams are performed in parallel at the same time, it may be assumed that the node has a capability of sensing different beams at the same time.

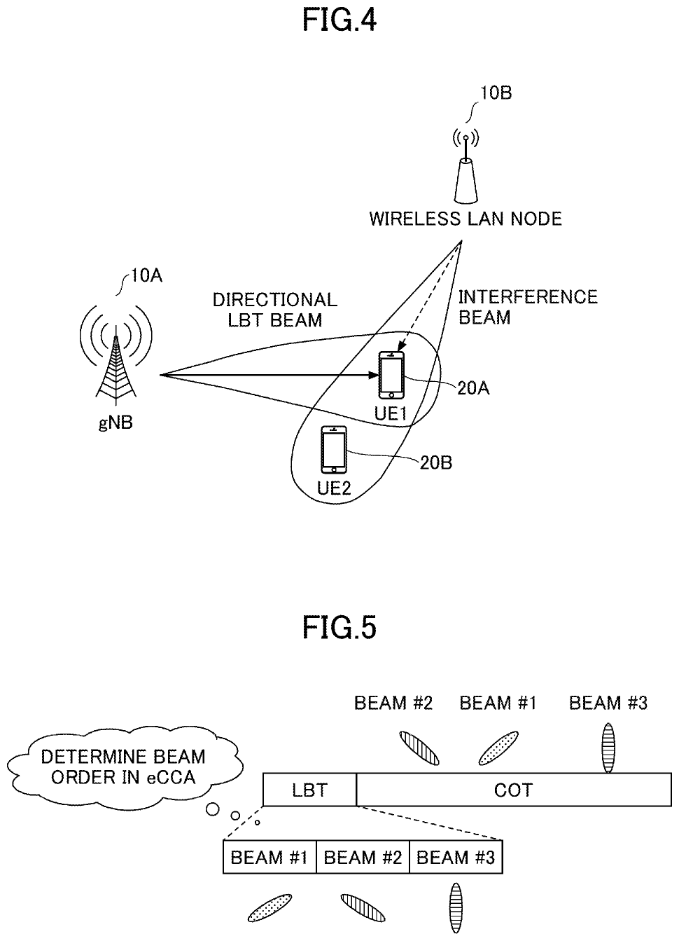

FIG. 4 is a drawing illustrating an example of an issue of a hidden terminal. There may be a case in which the channel power detected by a transmission-side node related to directional LBT and the channel power detected by a reception-side node related to directional LBT are different. As shown in FIG. 4, when the gNB directs the directional LBT beam toward the UE1, the hidden terminal issue arises in the UE1 because the UE1 also receives an interference beam from a wireless LAN node that cannot be detected by the gNB.

Considering the hidden terminal issue, for example, the reception-side node may perform and report legacy RSSI (Received Signal Strength Indicator) measurements. In addition, the reception-side node may perform an AP-CSI (Aperiodic Channel state information) report. In addition, the reception-side node may perform eCCA and may perform category 2 LBT.

Here, in a case where per-beam LBT is performed at the time of MU-MIMO transmission and the per-beam LBT is performed in the time division multiplexing fashion, when an operation is assumed in which, after an eCCA related to one beam is performed, an eCCA related to another beam is performed and no transmission is performed between the two eCCAs, it is necessary to determine operations described in the following 1) to 3).

1) How to determine the order of beams to be applied to LBT
2) An operation in a case where an LBT applying a beam, in the LBT applying a plurality of beams, fails
3) How to specify or determine whether a result of sending related to a beam is valid after sensing related to another beam is performed

FIG. 5 is a diagram illustrating an example (1) of eCCA in an embodiment of the present invention. As illustrated in FIG. 5, in a case where a plurality of beams are used for transmission in COT, a base station 10 or a terminal 20 may determine which order of the plurality of beams is applied to sensing to be performed in LBT. The order of beams to be applied to LBT may be determined as described in 1) to 5) below.

1) The order of all of or some of applicable sensing beams may be determined by RRC signaling. For example, in an example illustrated in FIG. 5, performing sensing in the order of beam #3, beam #2, and beam #1 may be configured by RRC signaling.
2) The order of all of or some of applicable sensing beams may be determined randomly.
3) The order of all of or some of applicable sensing beams may be determined by a parameter of each sensing beam. For example, in a case where the contention window length, a CWp value, is independently stored for each beam, the order of sensing beams may be determined based on the CWp values. For example, the order of sensing beams may be determined based on the ascending order or descending order of the CWp values.
4) The order of all of or some of applicable sensing beams may be determined based on the order of beams transmitted by using time division multiplexing in the COT. For example, in an example illustrated in FIG. 5, the order of transmissions in the COT is beam #2, beam #1, and beam #3, and thus, the sensing may be performed in the order of beam #2, beam #1, and beam #3.
5) The order of all of or some of applicable sensing beams may be determined based on the TCI state ID (Transmission Configuration Indicator state ID) or SRI (Sounding Reference Signal Resource Indicator). For example, in a case where beam #1 is associated with TCI state ID #2 and beam #2 is associated with TCI state #1, the order of sensing beams may be beam #2, beam #1.

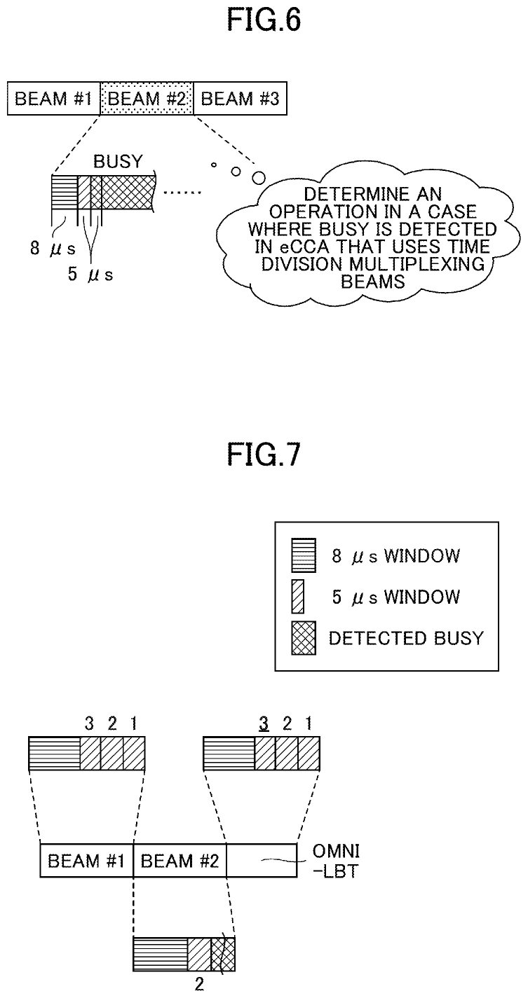

FIG. 6 is a diagram illustrating an example (2) of eCCA in an embodiment of the present invention. As illustrated in FIG. 6, in a case where a busy state is detected with respect to a beam in eCCA that uses time division multiplexing beams, the base station 10 and the terminal 20 may perform an operation described in A) to D) below.

A) May perform switching to the omni-directional LBT, or may perform switching to LBT that uses a wider sensing beam. The wider sensing beam may be a beam that includes a beam for which the busy state is detected.
B) May continue sensing using a beam for which the busy state is detected until LBT is successful, that is, until the busy state is cleared. In addition, for example, the sensing using a beam for which the busy state is detected may be continued until LBT becomes successful or until a timer expires. For example, the name of the timer may be an eCCA beam timer. In a case where LBT becomes successful before the timer expires, transition to sensing using another beam may be performed. In a case where LBT does not become successful before the timer expires, that is, in a case where the 50 timer expires before LBT becomes successful, transition to sensing using another beam may be performed or LBT may be stopped. The LBT to be stopped may be only an LBT related to a beam for which the state is a busy state, or may be LBTs related to all of the time division multiplexing beams.
C) In a case where the busy state is detected with respect to a beam, the LBT may be stopped. The LBT to be stopped may be only an LBT related to a beam for which the state is a busy state, or may be LBTs related to all of the time division multiplexing beams.
D) In a case where the busy state is detected with respect to a beam, transition to the sensing using another beam may be performed.

In the above-described B) to D), in a case where LBTs have been performed with respect to all of the sensing beams and an LBT with respect to a certain beam fails, the base station 10 or the terminal 20 may perform an operation described in 1) to 3) below.

### 1) End LBT

2) Perform sensing using a wider single beam that covers the beam for which the LBT has failed
3) Perform again the sensing using the beam for which the LBT has failed

Hereinafter, an operation related to the above-described A) will be described. The sensing using an omni-directional LBT or using a wider beam may be an LBT accompanied by a random backoff, or may be a single LBT not accompanied by a random backoff. In a case where the LBT is performed by switching to a wider beam, the wider beam may include multiple beams to be applied in the COT to be transmitted, or may include a beam for which the LBT has failed and/or a beam for which the sensing has not been performed. In other words, a beam for which the sensing is successful may be excluded from the wider beam.

In a case where the sensing using an omni-directional LBT or using a wider beam is an LBT accompanied by a random backoff, the random backoff counter may be reset, or the random backoff counter of the last LBT may be continuously used.

FIG. 7 is a drawing illustrating an example (1) of LBT in an embodiment of the present invention. As illustrated in FIG. 7, when an LBT using a beam fails and is switched to an omni-directional LBT or an LBT using a wider beam, the random backoff counter may be reset. FIG. 7 illustrates an example of performing an LBT using an omni-direction or an LBT using a wider beam with the random backoff counter N=3, in a case where the busy state is detected in the last LBT when the random backoff counter, N, is equal to 1.

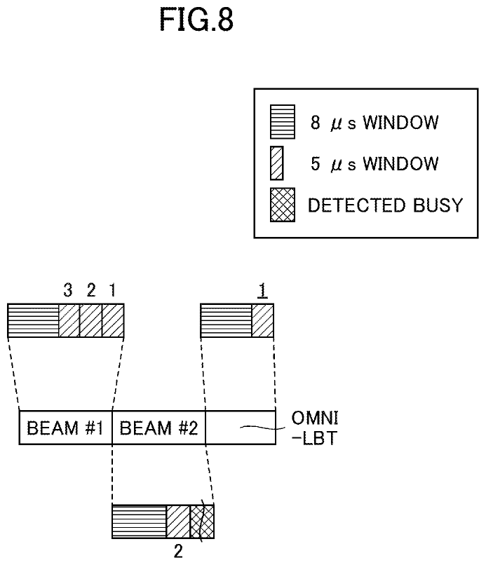

FIG. 8 is a drawing illustrating an example (2) of LBT in an embodiment of the present invention. As illustrated in FIG. 8, when an LBT using a beam fails and is switched to an omni-directional LBT or an LBT using a wider beam, the random backoff counter may be continuously used. FIG. 8 illustrates an example of performing an LBT using an omni-direction or a wider beam with the random backoff counter N=1, in a case where the busy state is detected in the last LBT when the random backoff counter, N, is equal to 1.

Performing of the omni-directional LBT or the LBT using a wider beam may be ended when the omni-directional LBT or the LBT using a wider beam is successful. In addition, performing of the omni-directional LBT or the LBT using a wider beam may be ended when the omni-directional LBT or the LBT using a wider beam is successful or when the timer expires. For example, the name of the timer may be an eCCA omni-timer.

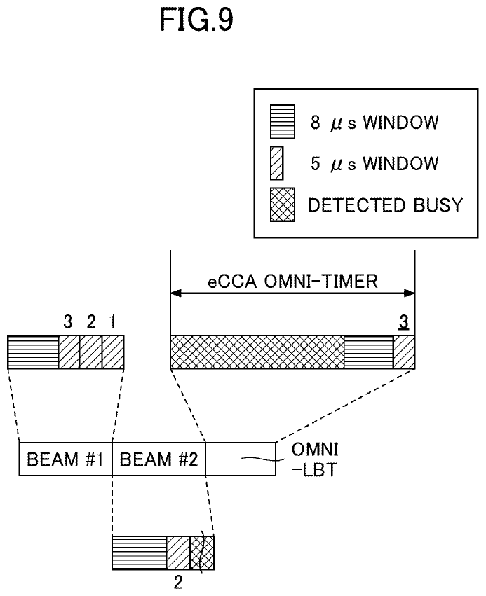

FIG. 9 is a drawing illustrating an example (3) of LBT in an embodiment of the present invention. As illustrated in FIG. 9, the eCCA omni-timer may be started at the time when the omni-directional LBT or the LBT using a wider beam is started.

FIG. 9 illustrates an example in which the omni-LBT is interrupted when the eCCA omni-timer expires at the time of the random backoff counter N=3.

As described above, it is possible to prevent the omni-directional LBT or the LBT using a wider beam from being performed for a long period of time by using the eCCA omni-timer.

Note that, in a case where the omni-directional LBT or the LBT using a wider beam has succeeded, the base station 10 or the terminal 20 may determine the LBT using all sensing beams has succeeded.

Hereinafter, an operation related to the above-described B) will be described. In a case where an eCCA using a beam fails, the LBT may be continued until the eCCA using the beam succeeds, and transition to an eCCA using another beam may be performed after the eCCA using the beam succeeds.

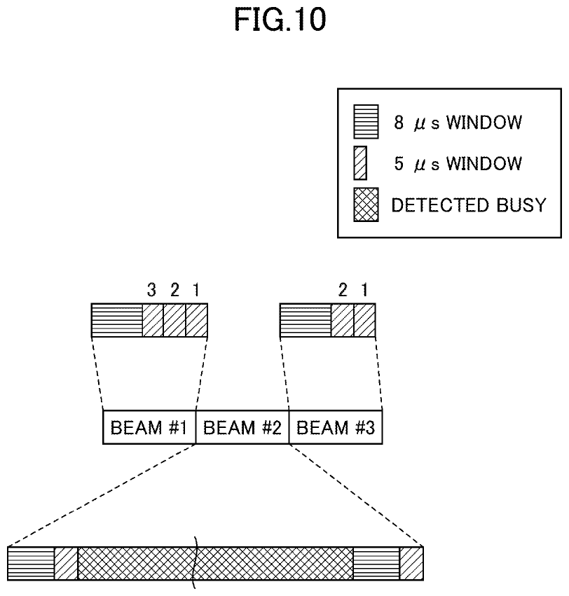

FIG. 10 is a drawing illustrating an example (4) of LBT in an embodiment of the present invention. As illustrated in FIG. 10, the LBT may be continued until the eCCA using beam #2 succeeds, and, after the successful eCCA using beam #2, transition to an eCCA using beam #3 may be performed.

In addition, in a case where an eCCA using a beam fails, the LBT may be continued until the eCCA using the beam succeeds or until an eCCA beam timer expires. The eCCA beam timer may be started at the time when the eCCA using the beam is started, or the eCCA beam timer may be started at the time when a busy state using the beam is detected. The eCCA beam timer may be configured in common for all sensing beams, or may be configured independently for each beam or for each beam set.

In a case where the eCCA using a beam for which the eCCA has failed succeeds before the eCCA beam timer expires, transition to an eCCA using another beam may be performed. In addition, in a case where the eCCA using a beam for which the eCCA has failed does not become successful before the eCCA beam timer expires, that is, in a case where the eCCA beam timer expires before the eCCA using a beam for which the eCCA has failed becomes successful, transition to an eCCA using another beam may be performed, or all LBTs may be interrupted.

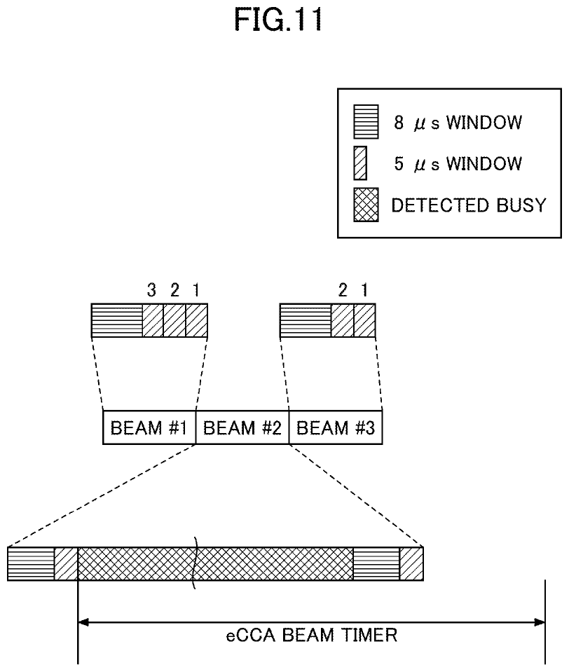

FIG. 11 is a drawing illustrating an example (5) of LBT in an embodiment of the present invention. As illustrated in FIG. 11, in a case where the eCCA using beam #2 for which the eCCA has failed succeeds before the eCCA beam timer expires, transition to an eCCA using another beam #3 may be performed.

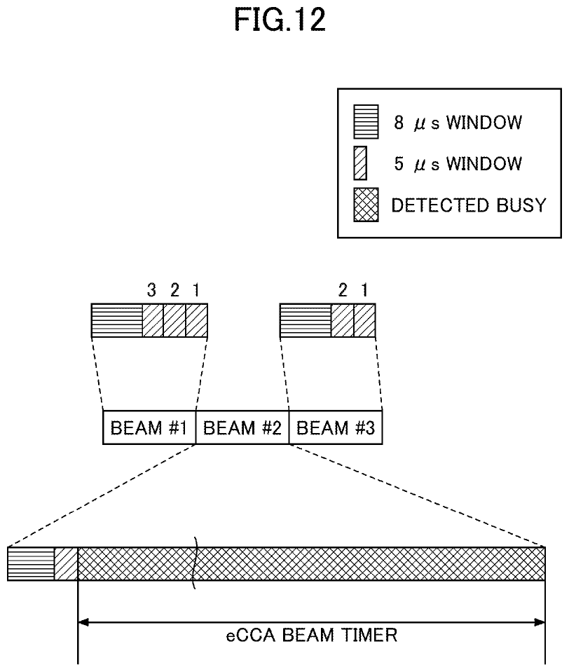

FIG. 12 is a drawing illustrating an example (6) of LBT in an embodiment of the present invention. As illustrated in FIG. 12, in a case where the eCCA using beam #2 for which the eCCA has failed does not become successful before the eCCA beam timer expires, that is, in a case where the eCCA beam timer expires without having the eCCA using beam #2 for which the eCCA has failed become successful, transition to an eCCA using another beam #3 may be performed.

Hereinafter, an operation related to the above-described C) will be described. In a case where an eCCA using a beam fails, all LBTs may be interrupted.

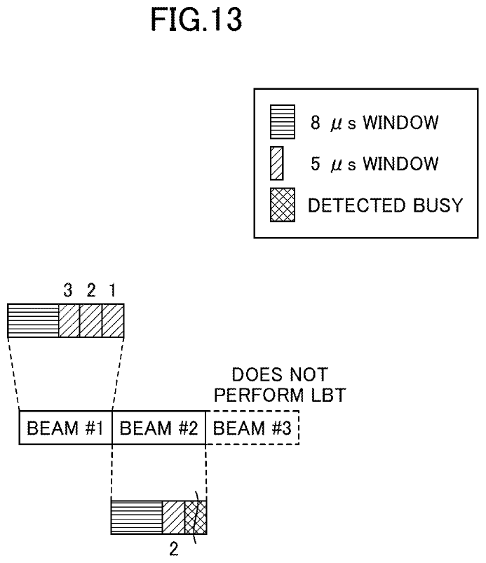

FIG. 13 is a drawing illustrating an example (7) of LBT in an embodiment of the present invention. As illustrated in FIG. 13, in a case where an eCCA using beam #2 fails, an eCCA using beam #3 for which the sensing has not been performed is not required to be performed by interrupting the LBT.

In addition, in a case where an eCCA using a beam fails, transition to an eCCA using another beam may be performed.

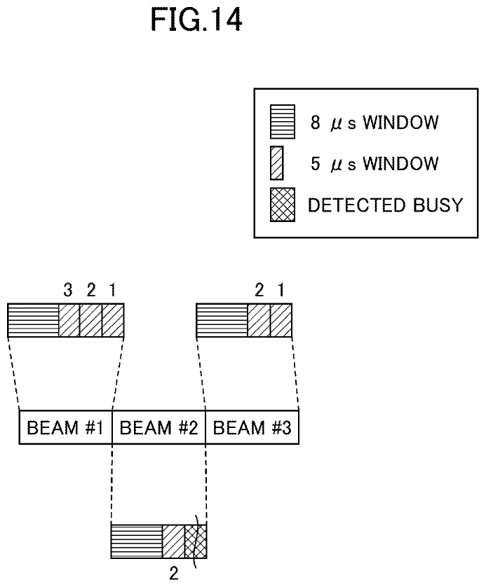

FIG. 14 is a drawing illustrating an example (8) of LBT in an embodiment of the present invention. As illustrated in FIG. 14, in a case where an eCCA using beam #2 fails, transition to an eCCA using beam #3 may be performed.

After performing the sensing using all beams, in a case where sensing using a beam has failed, it is not required to determine to interrupt the LBT. For example, COT related to sensing-succeeded beams other than sensing-failed beams may be obtained according to the LBT.

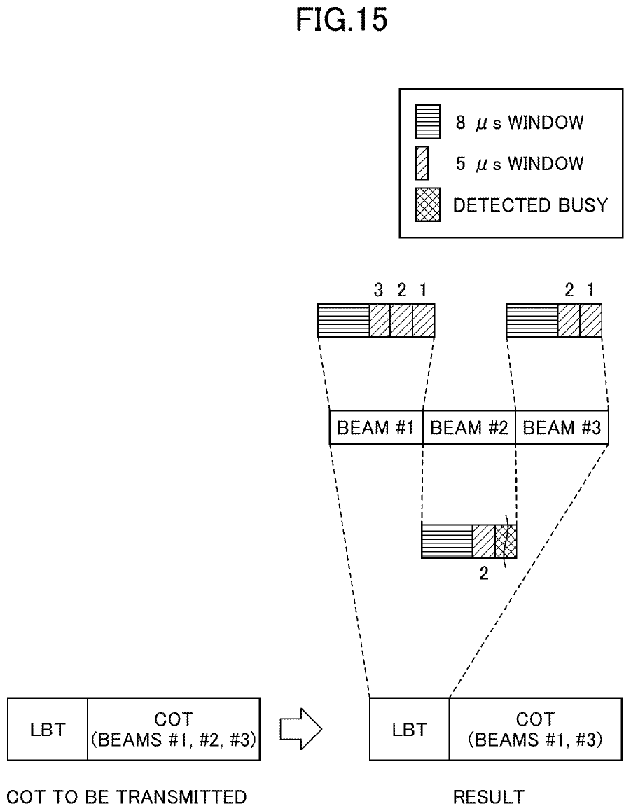

FIG. 15 is a drawing illustrating an example (9) of LBT in an embodiment of the present invention. As illustrated in FIG. 15, beam #1, beam #2 and beam #3 are applied to COT to be transmitted. In a case where only an eCCA using beam #2 fails, COT may be obtained in which beam #1 and beam #3 can be applied according to the LBT.

In addition, after performing the sensing using all beams, in a case where sensing using a beam has failed, the sensing may be retried using a single wide beam that covers the beam for which the sensing has failed. The random backoff counter with respect to the retry may be reset or may be used continuously. In a case where the retry of the sensing using the wide beam is successful, the LBT using all sensing beams may be determined to be successful.

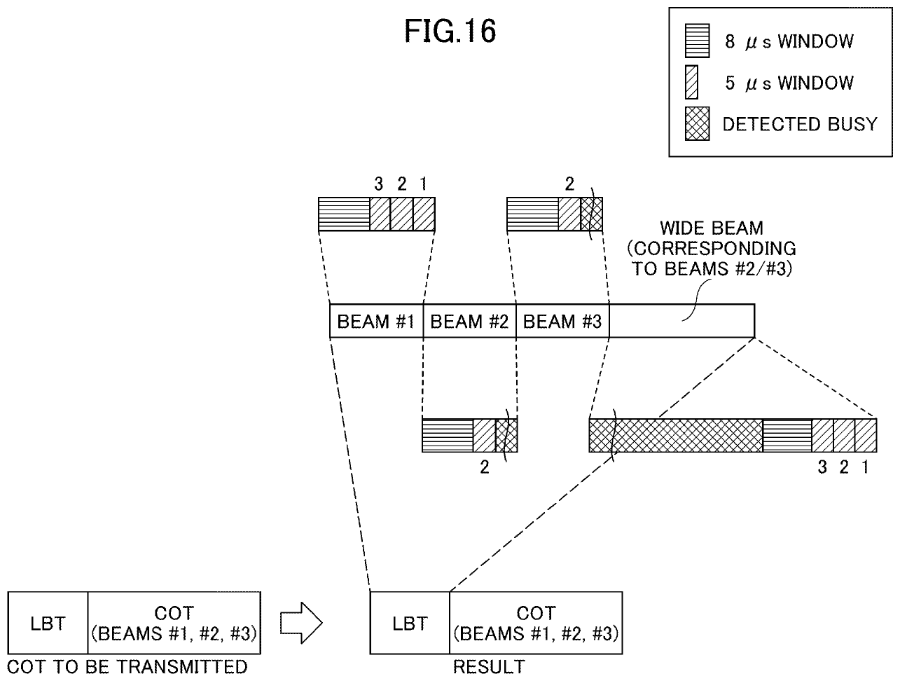

FIG. 16 is a drawing illustrating an example (10) of LBT in an embodiment of the present invention. As illustrated in FIG. 16, beam #1, beam #2 and beam #3 are applied to COT to be transmitted. When eCCAs using beam #2 and beam #3 have failed, the sensing may be retried using a wider beam that covers beam #2 and beam #3. In a case where the retry is successful, the COT may be obtained in which beam #1, beam #2, and beam 3 can be applied.

50 In addition, the time length of the retry may be limited by a timer. In other words, the sensing using the wider beam may be performed until the timer expires. For example, the timer may be referred to as an eCCA retry timer.

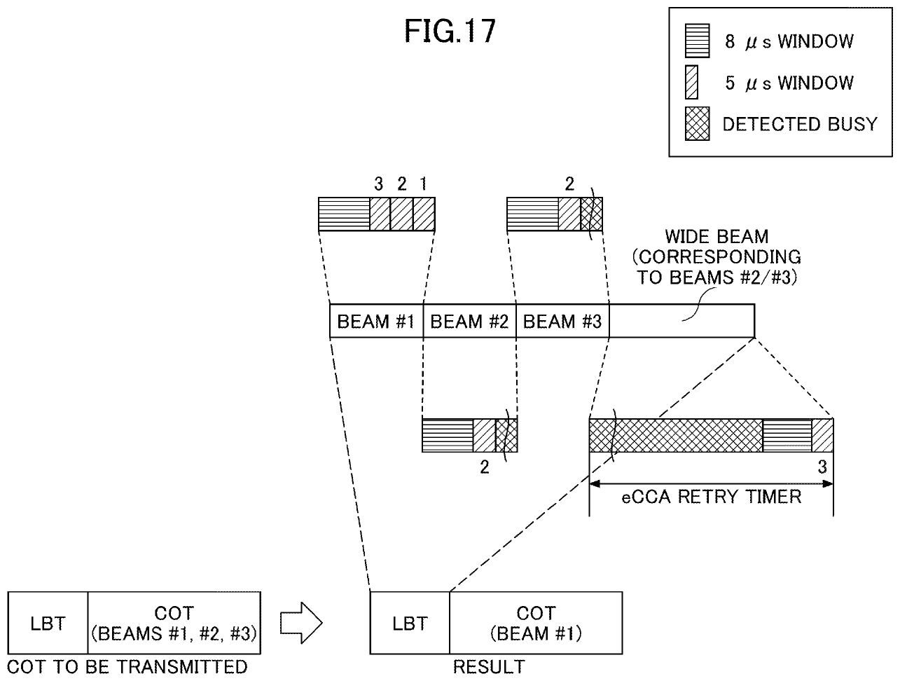

FIG. 17 is a drawing illustrating an example (11) of LBT in an embodiment of the present invention. As illustrated in FIG. 17, beam #1, beam #2 and beam #3 are applied to COT to be transmitted. When an eCCA using beam #2 and an eCCA using beam #3 have failed, the sensing may be retried using a wider beam that covers beam #2 and beam #3. The eCCA retry timer may be started at the time of the start of the retry. An example illustrated in FIG. 17 is a case in which the retry does not become successful before the eCCA retry timer expires, and the COT may be obtained in which only beam #1 can be applied according to the LBT.

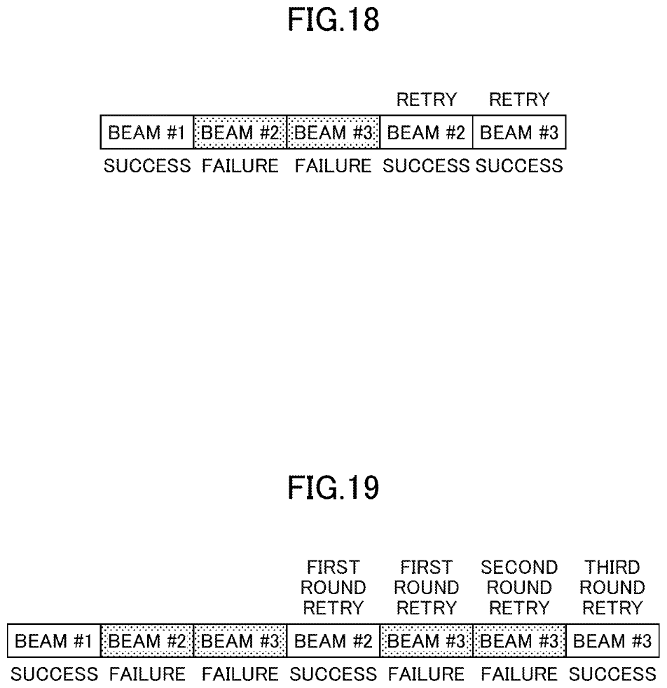

FIG. 18 is a drawing illustrating an example (12) of LBT in an embodiment of the present invention. As illustrated in FIG. 18, after one round of LBT using all sensing beams is performed, the LBT may be retried for each beam for which the sensing has failed. FIG. 18 illustrates an example in which the sensing beams are beam #1, beam #2, and beam #3, an eCCA using beam #2 and an eCCA using beam #3 fail, and the eCCA using beam #2 and the eCCA using beam #3 are retried. In the LBT in which the eCCA is retried for each beam, the random backoff counter may be reset or may be used continuously.

In a case where the busy state is detected in the retried eCCA related to a beam, the sensing may be continued until the eCCA related to the beam becomes successful. In addition, a timer may be configured that limits a total sum of retry periods of sensing for respective beams. For example, the timer may be referred to as an eCCA retry timer for all. The eCCA retry-all timer may be started at the beginning of the entire LBT using respective beams. In a case where the eCCA retry-all timer expires, all LBTs may be interrupted.

In addition, in a case where the busy state is detected in the retried eCCA related to a beam, the sensing may be continued until the eCCA related to the beam becomes successful or until the timer expires. For example, the timer may be referred to as an eCCA retry beam timer. In a case where the retried eCCA does not become successful before the eCCA retry beam timer expires, transition to a retry of an eCCA using another beam may be performed or all LBTs may be interrupted.

In addition, in a case where the busy state is detected in the retried eCCA related to a beam, transition to a retry of an eCCA using another beam may be performed immediately.

In addition, in a case where the busy state is detected in the retried eCCA related to a beam, all LBTs may be interrupted.

FIG. 19 is a drawing illustrating an example (13) of LBT in an embodiment of the present invention. As illustrated in FIG. 19, after one round of LBT using all sensing beams is performed, the LBT for each beam for which the sensing has failed may be retried, and further, retrying the LBT for each beam for which the retried sensing has failed may be repeated. FIG. 19 illustrates an example in which the sensing beams are beam #1, beam #2, and beam #3, an eCCA using beam #2 and an eCCA using 50 beam #3 fail, the eCCA using beam #2 becomes successful and the eCCA using beam #3 fails in the first round of retrying, the eCCA using beam #3 fails in the second round of retrying, and the eCCA using beam #3 becomes successful in the third round of retrying.

The eCCA retrying may be limited as described in the following 1) and 2).

1) The limited number of retrying rounds may be configured. For example, the limited number may be referred to as the maximum retry round. The limited number may be defined by technical specifications, or may be configured by RRC signaling. Regarding the limited number, a common value among the beams may be configured, or an independent value may be configured for each beam. The limited number may be 1, or may be a value greater than 1.

2) A timer may be configured that limits a total sum of LBT retry periods for respective beams. For example, the timer may be referred to as an eCCA retry round timer. The timer may be started at the time of the start of the first round of retry.

In a case where the busy state is continuously detected even at the time when the LBT retry round for each beam reaches the maximum retry round or at the time when the eCCA retry round timer expires, all LBTs may be interrupted.

The following option 1) to option 5) may be performed in order to maintain the result validity of LBT sensing that was performed in the past.

Option 1) The number of time division multiplexing beams in LBT may be limited. For example, the maximum number of time division multiplexing beams in LBT may be defined by technical specifications, or may be configured by RRC signaling. In a case where the number of time division multiplexing beams required for sensing exceeds the maximum number, the sensing for each beam according to time division multiplexing is not required to be applied. In addition, in a case where the number of time division multiplexing beams required for sensing exceeds the maximum number, the sensing for each beam may be performed in a range that does not exceed the maximum number, and the LBT may be interrupted if the maximum number is exceeded.

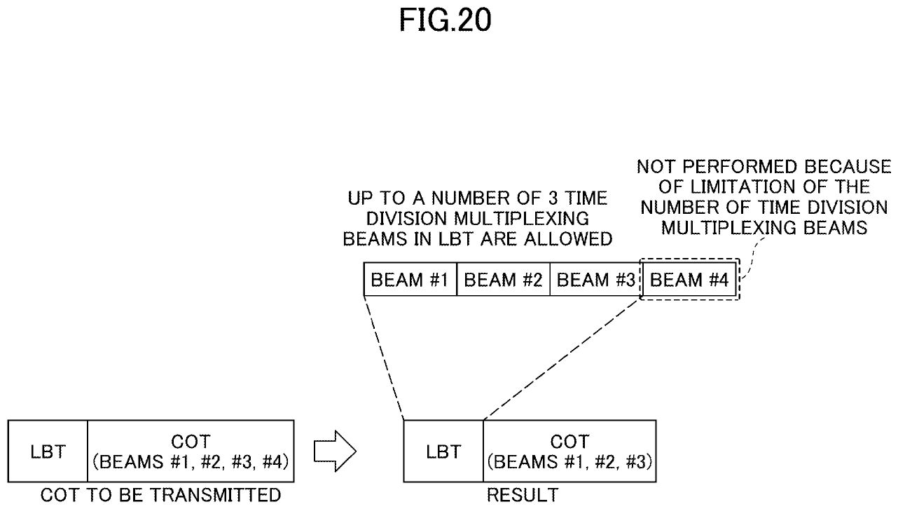

FIG. 20 is a drawing illustrating an example (14) of LBT in an embodiment of the present invention. As illustrated in FIG. 20, beam #1, beam #2, beam #3, and beam #4 are applied to COT to be transmitted. It is assumed in FIG. 20 that the number of time division multiplexing beams in LBT is allowed to be up to three. The eCCAs using beam #1, beam #2, and beam #3 are performed and the eCCA using beam #4 is not performed. The COT in which beam #1, beam #2, and beam 3 can be applied may be obtained according to the LBT.

In addition, in a case where the number of time division multiplexing beams in LBT exceeds the maximum number, the sensing using a wider beam by integrating the sensing using multiple beams may be performed, or multiple sensing operations for respective beams may be simultaneously performed. The number of time division multiplexing beams in LBT may be caused to be equal to or less than the maximum number by integrating sensing operations using multiple beams into a sensing operation using a wider beam.

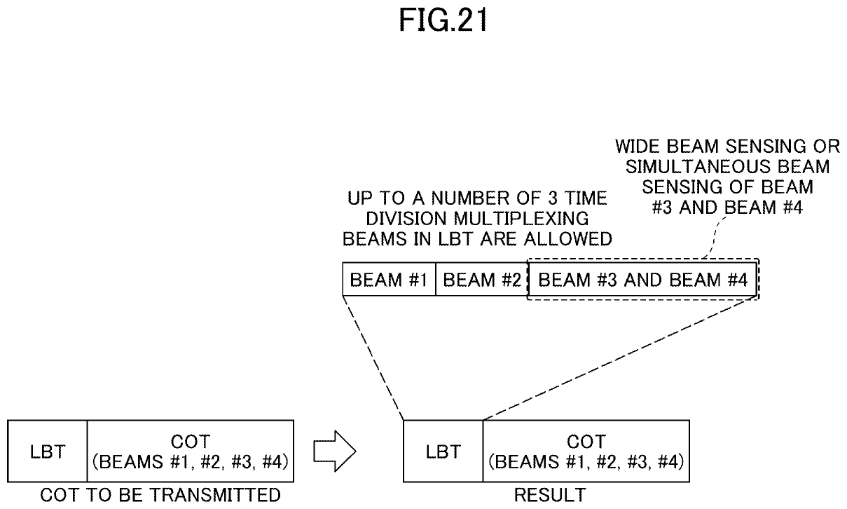

FIG. 21 is a drawing illustrating an example (15) of LBT in an embodiment of the present invention. As illustrated in FIG. 21, beam #1, beam #2, beam #3, and beam #4 are applied to COT to be transmitted. It is assumed in FIG. 21 that the number of time division multiplexing beams in LBT is allowed to be up to three. As illustrated in FIG. 21, an eCCA using a wider beam that covers beam #3 and beam #4 may be performed, or sensing operations using beams of beam #3 and beam #4, respectively, may simultaneously performed.

Option 2) Before the start of COT, a one-time one-shot LBT using each sensing beam for which the eCCA has been successful in the past may be performed. The one-shot LBTs may be performed in a time division multiplexing manner or may be performed simultaneously. In a case where the one-shot LBTs are performed in a time division multiplexing manner, the order of sensing beams may be the same as, or different from, the order of performing eCCAs in the past. In addition, the contention window to be applied to the one-shot LBT may be freely configured.

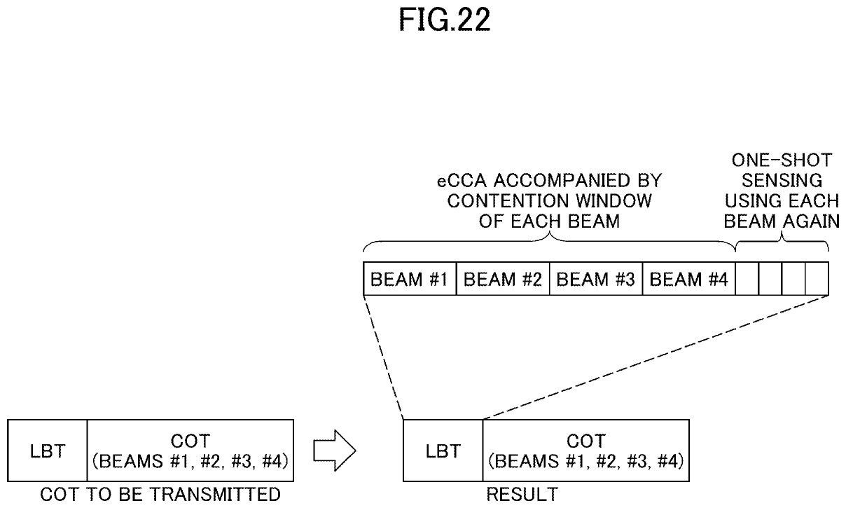

FIG. 22 is a drawing illustrating an example (16) of LBT in an embodiment of the present invention. As illustrated in FIG. 22, beam #1, beam #2, beam #3, and beam #4 are applied to COT to be transmitted. As illustrated in FIG. 22, the one-shot LBT applying each beam for which the eCCA is successful may be performed before the start of COT. In a case where the one-shot LBT is successful, the COT in which beam #1, beam #2, beam #3, and beam 4 can be applied may be obtained.

Option 3) Before the start of COT, a one-time one-shot omni-directional LBT may be performed.

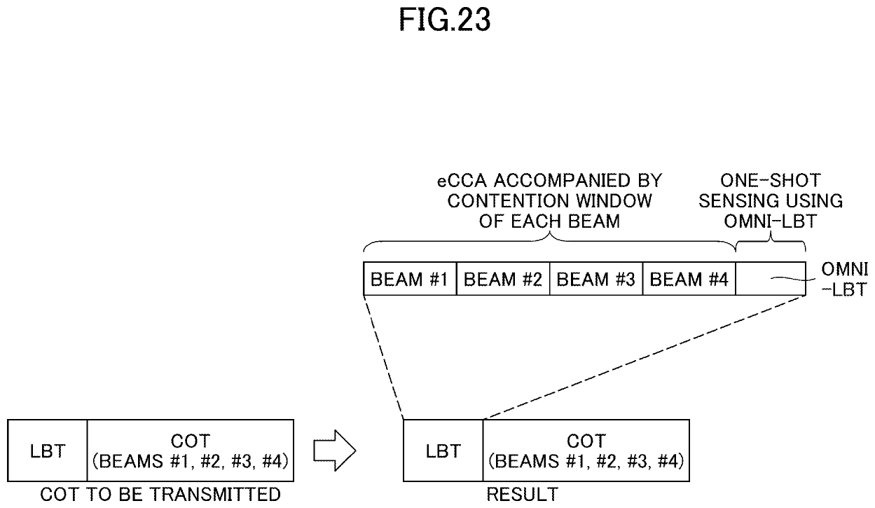

FIG. 23 is a drawing illustrating an example (17) of LBT in an embodiment of the present invention. As illustrated in FIG. 23, beam #1, beam #2, beam #3, and beam #4 are applied to COT to be transmitted. As illustrated in FIG. 23, a one-shot omni-directional LBT may be performed before the start of COT. In a case where the one-shot omni-directional LBT is successful, the COT in which beam #1, beam #2, beam #3, and beam #4 can be applied may be obtained.

Option 4) A timer may be configured that limits a total sum of all LBT periods for obtaining a COT. For example, the timer may be referred to as an eCCA timer. In a case where the eCCA timer expires, the LBT may be interrupted. After the eCCA timer expires, the LBT is not required to be performed.

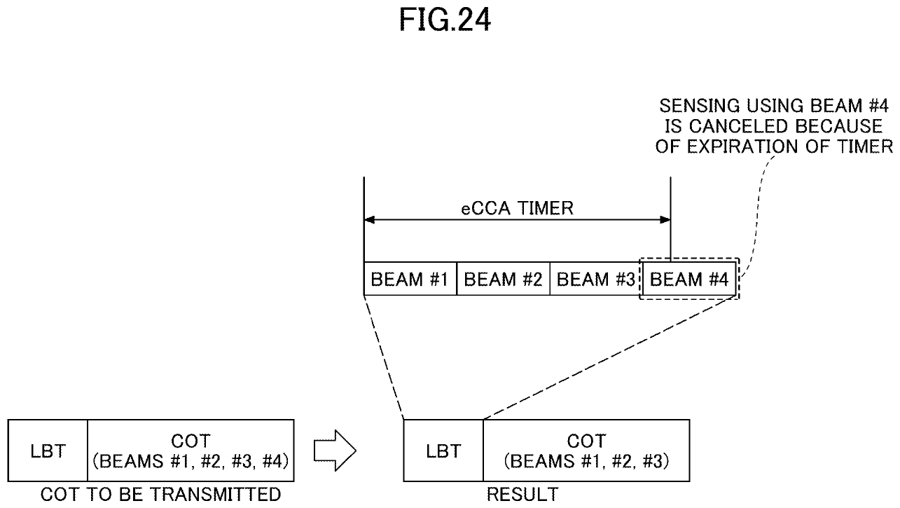

FIG. 24 is a drawing illustrating an example (18) of LBT in an embodiment of the present invention. As illustrated in FIG. 24, beam #1, beam #2, beam #3, and beam #4 are applied to COT to be transmitted. As illustrated in FIG. 24, the eCCA timer expires in the middle of performing the eCCA using beam #4, the sensing using beam #4 is canceled. Therefore, in an example illustrated in FIG. 24, the COT in which beam #1, beam #2, and beam #3 can be applied may be obtained.

Option 5) A fixed period length for determining that the sensing result of the LBT performed in the past is valid may be configured. In a case where the gap between the time point when an eCCA was successful in the past and the time point of transmission is within the fixed period length, an additional LBT related to the eCCA is not required to be performed. In a case where the gap between the time point when an eCCA was successful in the past and the time point of transmission exceeds the fixed period length, the above-described option 2) or option 3) may be performed. The fixed period length may be described as, for example, 8 microseconds+5 microseconds*n.

In a case where at least there is a beam for which the eCCA is not successful when the LBT is interrupted or completed, the beam for which the eCCA is not successful is not required to be used in the COT. Only beams for which the eCCA is successful may be applied to the COT.

In addition, in a case where at least there is a beam for which the eCCA is not successful when the LBT is interrupted or completed, obtaining the COT may be determined to have failed.

In a case where eCCAs using multiple beams in LBT are all successful, the COT may be obtained in which all of the multiple beams can be applied.

Note that the operation related to the LBT described above may be performed by the base station 10 or by the terminal 20. Note that the operation related to the LBT described above may be applicable to a specific frequency band. For example, the operation related to the LBT described above may be applicable to FR 2-2 of 52.6-71 GHz.

Note that the LBT, eCCA or sensing in an embodiment of the present invention may involve a random backoff, a one-time one-shot backoff, or may perform sensing in a certain sensing slot.

Note that which operation of the above described embodiments can be performed may be configured by an upper layer parameter, may be reported by the terminal 20 as the UE capability, may be defined by technical specifications, or may be determined by a combination of the upper-layer parameter configuration and the UE capability.

Note that, in order to obtain the COT in which multiple beams are applied, the UE capability may be defined to indicate whether the terminal 20 supports LBT in which sensing for each beam according to the time division multiplexing is performed. In addition, in order to obtain the COT in which multiple beams are applied, the UE capability may be defined to indicate whether the terminal 20 supports a UE side operation in a case where the base station 10 performs an LBT in which the sensing for each beam according to time division multiplexing is performed.

Note that, based on the RRC configuration, the UE capability may be defined to indicate whether the terminal 20 supports LBT in which sensing for each beam according to time division multiplexing is performed for obtaining the COT in which multiple beams are applied. In addition, in order to obtain the COT in which multiple beams are applied, the UE capability may be defined to indicate whether the terminal 20 supports a UE side operation based on the RRC configuration in a case where the base station 10 performs an LBT in which the sensing for each beam according to time division multiplexing is performed.

50 Note that the UE capability may be defined to indicate whether the terminal 20 supports an operation of continuing the sensing using a beam for which the busy state is detected when the busy state is detected in the sensing for each beam according to time division multiplexing. In addition, the UE capability may be defined to indicate whether the terminal 20 supports a UE side operation in a case where the base station 10 performs an operation of continuing the sensing using a beam for which the busy state is detected when the busy state is detected in the sensing for each beam according to time division multiplexing.

Note that the UE capability may be defined to indicate whether the terminal 20 supports an operation of starting the COT. The operation of starting the COT may be starting an operation for obtaining the COT.

Note that the UE capability may be defined to indicate whether the terminal 20 supports a one-time one-shot LBT after the completion of sensing using each beam according to time division multiplexing. In addition, the UE capability may be defined to indicate whether the terminal 20 supports a UE side operation in a case where the base station 10 performs a one-time one-shot LBT after the completion of sensing using each beam according to time division multiplexing.

Note that the UE capability may be defined to indicate whether the terminal 20 supports an omni-directional LBT after the completion of sensing using each beam according to time division multiplexing. In addition, the UE capability may be defined to indicate whether the terminal 20 supports a UE side operation in a case where the base station 10 performs an omni-directional LBT after the completion of sensing using each beam according to time division multiplexing. Note that the UE capability may be defined to indicate whether the terminal 20 supports a one-time one-shot omni-directional LBT after the completion of sensing using each beam according to time division multiplexing. In addition, the UE capability may be defined to indicate whether the terminal 20 supports a UE side operation in a case where the base station 10 performs a one-time one-shot omni-directional LBT after the completion of sensing using each beam according to time division multiplexing.

Note that the UE capability may be defined to indicate the maximum number of beams to be supported in the sensing using each beam according to time division multiplexing. In addition, the UE capability may be defined to indicate whether an operation is to be supported that limits the maximum number of beams to be supported in the sensing using each beam according to time division multiplexing.

In addition, the UE capability may be defined to indicate whether the terminal 20 supports a timer that indicates an upper limit of the LBT period at the time of expiration in the sensing using each beam according to time division multiplexing.

According to an embodiment of the present invention, the base station 10 or the terminal 20 can perform a directional LBT in which sensing using each beam according to time division multiplexing is performed.

In other words, it is possible to determine a beam to be applied to a directional LBT (Directional Listen before talk) in a radio communication system.

### (Device Configuration)

Next, a functional configuration example of the base station 10 and the terminal 20 for performing the processes and operations described above will be described. The base station 10 and terminal 20 include functions for implementing the embodiments described above. It should be noted, however, that each of the base stations 10 and the terminal 20 may include only some of the functions in an embodiment.

### <Base Station 10>

FIG. 25 is a drawing illustrating an example of a functional structure of a base station 10 according to an embodiment of the present invention. As shown in FIG. 25, the base station 10 includes a transmission unit 110, a reception unit 120, a configuration unit 130, and a control unit 140. The functional structure illustrated in FIG. 25 is merely an example. Functional divisions and names of functional units may be anything as long as operations according to an embodiment of the present invention can be performed.

The transmission unit 110 includes a function for generating a signal to be transmitted to the terminal 20 side and transmitting the signal wirelessly. Further, the transmission unit 110 transmits an inter-network-node message to another network node. The reception unit 120 includes a function for receiving various signals transmitted from the terminal 20 and acquiring, for example, information of a higher layer from the received signals. Further, the transmission unit 110 has a function to transmit NR-PSS, NR-SSS, NR-PBCH, DL/UL control signals, and the like to the terminal 20. Further, the reception unit 120 receives an inter-network-node message from another network node.

The configuration unit 130 stores preset information and various configuration information items to be transmitted to the terminal 20. Contents of the configuration information are, for example, information related to the LBT configuration.

The control unit 140 performs control related to the LBT configuration as described in the embodiments. In addition, the control unit 140 performs scheduling.

The functional units related to signal transmission in the control unit 140 may be included in the transmission unit 110, and the functional units related to signal reception in the control unit 140 may be included in the reception unit 120.

### <Terminal 20>

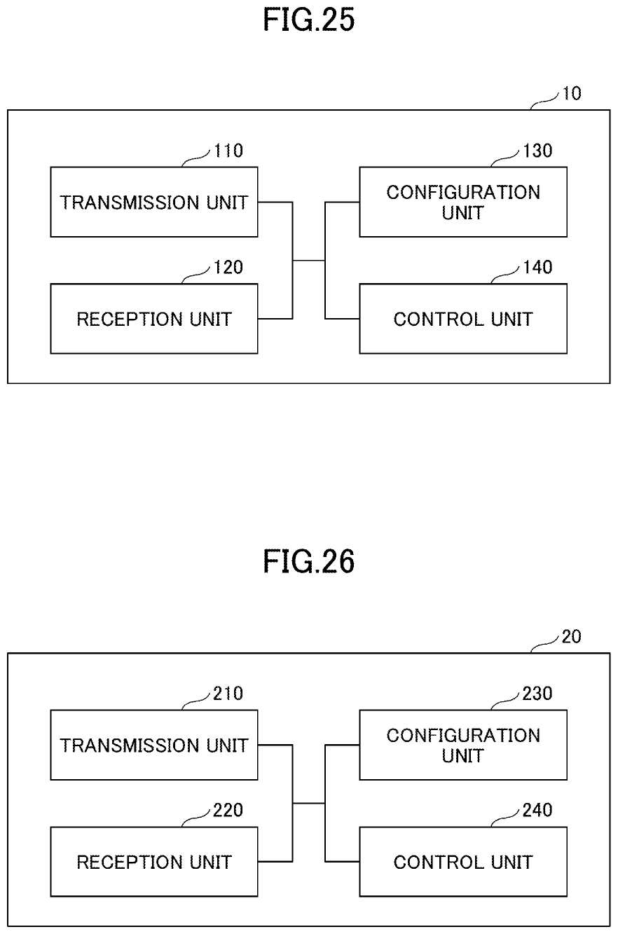

FIG. 26 is a drawing illustrating an example of a functional structure of a terminal 20 according to an embodiment of the present invention. As shown in FIG. 26, the terminal 20 includes a transmission unit 210, a reception unit 220, a configuration unit 230, and a control unit 240. The functional structure illustrated in FIG. 26 is merely an example. Functional divisions and names of functional units may be anything as long as operations according to an embodiment of the present invention can be performed.

The transmission unit 210 generates a transmission signal from transmission data and transmits the transmission signal wirelessly. The reception unit 220 receives various signals wirelessly and obtains upper layer signals from the received physical layer signals. Further, the reception unit 220 has a function for 50 receiving NR-PSS, NR-SSS, NR-PBCH, DL/UL/SL control signals, etc., transmitted from the base station 10. Further, for example, with respect to the D2D communications, the transmission unit 210 transmits, to another terminal 20, PSCCH (Physical Sidelink Control Channel), PSSCH (Physical Sidelink Shared Channel), PSDCH (Physical Sidelink Discovery Channel), PSBCH (Physical Sidelink Broadcast Channel), etc., and the reception unit 220 receives, from the another terminal 20, PSCCH, PSSCH, PSDCH, or PSBCH.

The configuration unit 230 stores various configuration information items received by the reception unit 220 from the base station 10. In addition, the configuration unit 230 also stores pre-configured configuration information. Contents of the configuration information are, for example, information related to the LBT configuration.

The control unit 240 performs control related to the LBT configuration as described in the embodiments. The functional units related to signal transmission in the control unit 240 may be included in the transmission unit 210, and the functional units related to signal reception in the control unit 240 may be included in the reception unit 220.

### (Hardware Structure)

In the above functional structure diagrams used for describing an embodiment of the present invention (FIG. 25 and FIG. 26), functional unit blocks are shown. The functional blocks (function units) are realized by a freely-selected combination of hardware and/or software. Further, realizing means of each functional block is not limited in particular. In other words, each functional block may be realized by a single apparatus in which multiple elements are coupled physically and/or logically, or may be realized by two or more apparatuses that are physically and/or logically separated and are physically and/or logically connected (e.g., wired and/or wireless). The functional blocks may be realized by combining the above-described one or more apparatuses with software.

Functions include, but are not limited to, judging, determining, calculating, processing, deriving, investigating, searching, checking, receiving, transmitting, outputting, accessing, resolving, selecting, establishing, comparing, assuming, expecting, and deeming; broadcasting, notifying, communicating, forwarding, configuring, reconfiguring, allocating, mapping, and assigning, etc. For example, a functional block (component) that functions to transmit is called a transmitting unit or a transmitter. In either case, as described above, the implementation method is not particularly limited.

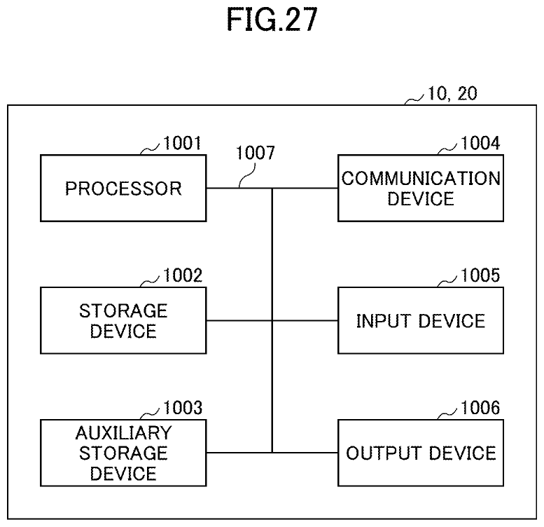

For example, the base station 10, terminal 20, etc., according to an embodiment of the present disclosure may function as a computer for processing the radio communication method of the present disclosure. FIG. 27 is a drawing illustrating an example of hardware structures of the base station 10 and terminal 20 according to an embodiment of the present invention. Each of the above-described base station 10 and the terminal 20 may be physically a computer device including a processor 1001, a storage device 1002, an auxiliary storage device 1003, a communication device 1004, an input device 1005, an output device 1006, a bus 1007, etc.

It should be noted that, in the descriptions below, the term “apparatus” can be read as a circuit, a device, a unit, etc. The hardware structures of the base station 10 and terminal 20 may include one or more of each of the devices illustrated in the figure, or may not include some devices.

Each function in the base station 10 and terminal 20 is realized by having the processor 1001 perform an operation by reading predetermined software (programs) onto hardware such as the processor 1001 and the storage device 1002, and by controlling communication by the communication device 1004 and controlling at least one of reading and writing of data in the storage device 1002 and the auxiliary storage device 1003.

The processor 1001 controls the entire computer by, for example, controlling the operating system. The processor 1001 may include a central processing unit (CPU) including an interface with a peripheral apparatus, a control apparatus, a calculation apparatus, a register, etc. For example, the above-described control unit 140, control unit 240, and the like, may be implemented by the processor 1001.

Further, the processor 1001 reads out onto the storage device 1002 a program (program code), a software module, or data from the auxiliary storage device 1003 and/or the communication device 1004, and performs various processes according to the program, the software module, or the data. As the program, a program is used that causes the computer to perform at least a part of operations according to an embodiment of the present invention described above. For example, the control unit 140 of the base station 10 illustrated in FIG. 25 may be realized by control programs that are stored in the storage device 1002 and are executed by the processor 1001.

Further, for example, the control unit 240 of the terminal 20 illustrated in FIG. 26 may be realized by control programs that are stored in the storage device 1002 and are executed by the processor 1001. The various processes have been described to be performed by a single processor 1001. However, the processes may be performed by two or more processors 1001 simultaneously or sequentially. The processor 1001 may be implemented by one or more chips. It should be noted that the program may be transmitted from a network via a telecommunication line.

The storage device 1002 is a computer-readable recording medium, and may include at least one of a ROM (Read Only Memory), an EPROM (Erasable Programmable ROM), an EEPROM (Electrically Erasable Programmable ROM), a RAM (Random Access Memory), etc. The storage device 1002 may be referred to as a register, a cache, a main memory, etc. The storage device 1002 is capable of storing programs (program codes), software modules, or the like, that are executable for performing communication processes according to an embodiment of the present invention.

The auxiliary storage device 1003 is a computer-readable recording medium, and may include at least one of, for example, an optical disk such as a CD-ROM (Compact Disc ROM), a hard disk drive, a flexible disk, a magneto optical disk (e.g., compact disc, digital versatile disc, Blu-ray (registered trademark) disk), a smart card, a flash memory (e.g., card, stick, key drive), a floppy (registered trademark) disk, a magnetic strip, etc. The above recording medium may be a database including the storage device 1002 and/or the auxiliary storage device 1003, a server, or any other appropriate medium.

The communication device 1004 is hardware (transmission and reception device) for communicating with computers via at least one of a wired network and a wireless network, and may be referred to as a network device, a network controller, a network card, a communication module, etc. The communication device 1004 may comprise a high frequency switch, duplexer, filter, frequency synthesizer, or the like, for example, to implement at least one of a frequency division duplex (FDD) and a time division duplex (TDD). For example, the transmitting/receiving antenna, the amplifier unit, the transmitting/receiving unit, the transmission line interface, and the like, may be implemented by the communication device 1004. The transmitting/receiving unit may be physically or logically divided into a transmitting unit and a receiving unit.

The input device 1005 is an input device that receives an external input (e.g., keyboard, mouse, microphone, switch, button, sensor). The output device 1006 is an output device that outputs something to the outside (e.g., display, speaker, LED lamp). It should be noted that the input device 1005 and the output device 1006 may be integrated into a single device (e.g., touch panel).

Further, the apparatuses including the processor 1001, the storage device 1002, etc., are connected to each other via the bus 1007 used for communicating information. The bus 1007 may include a single bus, or may include different buses between the apparatuses.

Further, each of the base station 10 and terminal 20 may include hardware such as a microprocessor, a digital signal processor (DSP), an ASIC (Application Specific Integrated Circuit), a PLD (Programmable Logic Device), a FPGA (Field Programmable Gate Array), etc., and a part or all of each functional block may be realized by the hardware. For example, the processor 1001 may be implemented by at least one of the above hardware elements.

### Embodiment Summary

As described above, according to an embodiment of the present invention, a base station is provided. The base station includes: a reception unit configured to perform time division multiplexing of a plurality of reception beams corresponding to a plurality of transmission beams applied for transmission in COT (Channel Occupancy Time), and to perform LBT (Listen before talk) in which sensing is performed by applying each of the plurality of reception beams; and a transmission unit configured to apply, to the transmission in the COT, a transmission beam corresponding to a reception beam, among the plurality of the reception beams, for which a busy state is not detected in the LBT.

According to the above-described configuration, the base station 10 or the terminal 20 can perform a directional LBT in which sensing using each beam according to time division multiplexing is performed. In other words, it is possible to determine a beam to be applied to a directional LBT (Directional Listen before talk) in a radio communication system.

The reception unit may perform sensing by applying each of the plurality of reception beams in an order of reception beams corresponding to an order of transmission beams to be applied in the COT.

According to the above-described configuration, the base station 10 or the terminal 20 can determine the order of beams to be applied to a directional LBT in which sensing using each beam according to time division multiplexing is performed.

The reception unit may perform LBT by applying an omni-directional beam or may perform LBT by applying a wider reception beam in a case where the busy state is detected in sensing in which one of the plurality of reception beams in the LBT is applied. According to the above-described configuration, the base station 10 or the terminal 20 can retry the LBT by applying an omni-directional beam or by applying a wider beam in a case where the busy state is detected in a directional LBT in which sensing using each beam according to time division multiplexing is performed.

The reception unit may continue sensing by applying the reception beam for which the busy state is detected until the busy state is cleared in a case where the busy state is detected in the sensing by applying one reception beam among the plurality of reception beams in the LBT. According to the above-described configuration, the base station 10 or the terminal 20 can retry the LBT until the busy state is cleared in a case in which the busy state is detected in the directional LBT in which sensing using each beam according to time division multiplexing is performed.

The reception unit may configure an upper limit to a number of reception beams applied to the sensing, and, in a case where a number of the plurality of reception beams exceeds the upper limit, the reception unit may perform the sensing by applying reception beams within the upper limit: by not applying some of the plurality of reception beams; or by performing the sensing by not applying some of the plurality of reception beams and by using a wider reception beam that includes reception beams that are not applied to the sensing. According to the above-described configuration, the base station 10 or the terminal 20 can maintain the validity of beams for which the LBT has already succeeded by configuring an upper limit to the number of beams in a directional LBT in which sensing using each beam according to time division multiplexing is performed.

In addition, according to an embodiment of the present invention, a communication method performed by a base station is provided. The communication method includes: performing time division multiplexing of a plurality of reception beams corresponding to a plurality of transmission beams applied for transmission in COT (Channel Occupancy Time); performing LBT (Listen before talk) in which sensing is performed by applying each of the plurality of reception beams; and applying, to the transmission in the COT, a transmission beam corresponding to a reception beam, among the plurality of the reception beams, for which a busy state is not detected in the LBT.

According to the above-described configuration, the base station 10 or the terminal 20 can perform a directional LBT in which sensing using each beam according to time division multiplexing is performed. In other words, it is possible to determine a beam to be applied to a directional LBT (Directional Listen before talk) in a radio communication system.

### Supplement of Embodiment

As described above, one or more embodiments have been described. The present invention is not limited to the above embodiments. A person skilled in the art should understand that there are various modifications, variations, alternatives, replacements, etc., of the embodiments. In order to facilitate understanding of the present invention, specific values have been used in the description. However, unless otherwise specified, those values are merely examples and other appropriate values may be used. The division of the described items may not be essential to the present invention. The things that have been described in two or more items may be used in a combination if necessary, and the thing that has been described in one item may be appropriately applied to another item (as long as there is no contradiction). Boundaries of functional units or processing units in the functional block diagrams do not necessarily correspond to the boundaries of physical parts. Operations of multiple functional units may be physically performed by a single part, or an operation of a single functional unit may be physically performed by multiple parts. The order of sequences and flowcharts described in an embodiment of the present invention may be changed as long as there is no contradiction. For the sake of description convenience, the base station 10 and the terminal 20 have been described by using functional block diagrams. However, the apparatuses may be realized by hardware, software, or a combination of hardware and software. The software executed by a processor included in the base station 10 according to an embodiment of the present invention and the software executed by a processor included in the terminal 20 according to an embodiment of the present invention may be stored in a random access memory (RAM), a flash memory, a read only memory (ROM), an EPROM, an EEPROM, a register, a hard disk (HDD), a removable disk, a CD-ROM, a database, a server, or any other appropriate recording medium.

Further, information indication may be performed not only by methods described in an aspect/embodiment of the present specification but also a method other than those described in an aspect/embodiment of the present specification. For example, the information indication may be performed by physical layer signaling (e.g., DCI (Downlink Control Information), UCI (Uplink Control Information)), upper layer signaling (e.g., RRC (Radio Resource Control) signaling, MAC (Medium Access Control) signaling, broadcast information (MIB (Master Information Block), SIB (System Information Block))), other signals, or combinations thereof. Further, RRC signaling may be referred to as an RRC message. The RRC signaling may be, for example, an RRC connection setup message, an RRC connection reconfiguration message, or the like.

Each aspect/embodiment described in the present disclosure may be applied to at least one of a system using LTE (Long Term Evolution), LTE-A (LTE-Advanced), SUPER 3G, IMT-Advanced, 4G (4th generation mobile communication system), 5G (5th generation mobile communication system), FRA (Future Radio Access), NR (new Radio), W-CDMA (registered trademark), GSM (registered trademark), CDMA2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), and other appropriate systems, and a next generation system enhanced therefrom. Further, multiple systems may also be applied in combination (e.g., at least one of LTE and LTE-A combined with 5G, etc.).

The order of processing steps, sequences, flowcharts or the like of an aspect/embodiment described in the present specification may be changed as long as there is no contradiction. For example, in a method described in the present specification, elements of various steps are presented in an exemplary order. The order is not limited to the presented specific order.

The particular operations, that are supposed to be performed by the base station 10 in the present specification, may be performed by an upper node in some cases. In a network including one or more network nodes including the base station 10, it is apparent that various operations performed for communicating with the terminal 20 may be performed by the base station 10 and/or another network node other than the base station 10 (for example, but not limited to, MME or S-GW). According to the above, a case is described in which there is a single network node other than the base station 10. However, a combination of multiple other network nodes may be considered (e.g., MME and S-GW).

The information or signals described in this disclosure may be output from a higher layer (or lower layer) to a lower layer (or higher layer). The information or signals may be input or output through multiple network nodes.

The input or output information may be stored in a specific location (e.g., memory) or managed using management tables. The input or output information may be overwritten, updated, or added. The information that has been output may be deleted. The information that has been input may be transmitted to another apparatus.

A decision or a determination in an embodiment of the present invention may be realized by a value (0 or 1) represented by one bit, by a boolean value (true or false), or by comparison of numerical values (e.g., comparison with a predetermined value).

Software should be broadly interpreted to mean, whether referred to as software, firmware, middle-ware, microcode, hardware description language, or any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL) and wireless technologies (infrared, microwave, etc.), at least one of these wired line technologies and wireless technologies is included within the definition of the transmission medium.

Information, a signal, or the like, described in the present specification may be represented by using any one of various different technologies. For example, data, an instruction, a command, information, a signal, a bit, a symbol, a chip, or the like, described throughout the present application, may be represented by a voltage, an electric current, electromagnetic waves, magnetic fields, a magnetic particle, optical fields, a photon, or a combination thereof.

It should be noted that a term used in the present specification and/or a term required for understanding of the present specification may be replaced by a term having the same or similar meaning. For example, a channel and/or a symbol may be a signal (signaling). Further, a signal may be a message. Further, the component carrier (CC) may be referred to as a carrier frequency, cell, frequency carrier, or the like.

As used in the present disclosure, the terms “system” and “network” are used interchangeably.

Further, the information, parameters, and the like, described in the present disclosure may be expressed using absolute values, relative values from predetermined values, or they may be expressed using corresponding different information. For example, a radio resource may be what is indicated by an index.

The names used for the parameters described above are not used as limitations. Further, the mathematical equations using these parameters may differ from those explicitly disclosed in the present disclosure. Because the various channels (e.g., PUCCH, PDCCH) and information elements may be identified by any suitable names, the various names assigned to these various channels and information elements are not used as limitations.

In the present disclosure, the terms “BS: Base Station”, “Radio Base Station”, “Base Station Apparatus”, “Fixed Station”, “NodeB”, “eNodeB (eNB)”, “gNodeB (gNB)”, “Access Point”, “Transmission Point”, “Reception Point”, “Transmission/Reception Point”, “Cell”, “Sector”, “Cell Group”, “Carrier”, “Component Carrier”, and the like, may be used interchangeably. The base station may be referred to as a macro-cell, a small cell, a femtocell, a picocell and the like.

The base station may accommodate (provide) one or more (e.g., three) cells. In the case where the base station accommodates a plurality of cells, the entire coverage area of the base station may be divided into a plurality of smaller areas, each smaller area may provide communication services by means of a base station subsystem (e.g., an indoor small base station or a remote Radio Head (RRH)). The term “cell” or “sector” refers to a part or all of the coverage area of at least one of the base station and base station subsystem that provides communication services at the coverage.

In the present disclosure, terms such as “mobile station (MS)”, “user terminal”, “user equipment (UE)”, “terminal”, and the like, may be used interchangeably.

There is a case in which the mobile station may be referred to, by a person skilled in the art, as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other appropriate terms.

At least one of the base station and the mobile station may be referred to as a transmission apparatus, reception apparatus, communication apparatus, or the like. The at least one of the base station and the mobile station may be a device mounted on the mobile station, the mobile station itself, or the like. The mobile station may be a vehicle (e.g., a car, an airplane, etc.), an unmanned mobile body (e.g., a drone, an automated vehicle, etc.), or a robot (manned or unmanned). At least one of the base station and the mobile station may include an apparatus that does not necessarily move during communication operations. For example, at least one of the base station and the mobile station may be an IoT (Internet of Things) device such as a sensor.

Further, the base station in the present disclosure may be read as the user terminal. For example, each aspect/embodiment of the present disclosure may be applied to a configuration in which communications between the base station and the user terminal are replaced by communications between multiple terminals 20 (e.g., may be referred to as D2D (Device-to-Device), V2X (Vehicle-to-Everything), etc.). In this case, the function of the base station 10 described above may be provided by the terminal 20. Further, the phrases “up” and “down” may also be replaced by the phrases corresponding to terminal-to-terminal communication (e.g., “side”). For example, an uplink channel, a downlink channel, or the like, may be read as a sidelink channel.

Further, the user terminal in the present disclosure may be read as the base station. In this case, the function of the user terminal described above may be provided by the base station.

The term “determining” used in the present specification may include various actions or operations. The “determining” may include, for example, a case in which “judging”, “calculating”, “computing”, “processing”, “deriving”, “investigating”, “looking up, search, inquiry” (e.g., looking up a table, database, or other data structures), or “ascertaining” is deemed as “determining”. Further, the “determining” may include a case in which “receiving” (e.g., receiving information), “transmitting” (e.g., transmitting information), “inputting”, “outputting”, or “accessing” (e.g., accessing data in a memory) is deemed as “determining”. Further, the “determining” may include a case in which “resolving”, “selecting”, “choosing”, “establishing”, “comparing”, or the like is deemed as “determining”. In other words, the “determining” may include a case in which a certain action or operation is deemed as “determining”. Further, “decision” may be read as “assuming”, “expecting”, or “considering”, etc.

The term “connected” or “coupled” or any variation thereof means any direct or indirect connection or connection between two or more elements and may include the presence of one or more intermediate elements between the two elements “connected” or “coupled” with each other. The coupling or connection between the elements may be physical, logical, or a combination thereof. For example, “connection” may be read as “access”. As used in the present disclosure, the two elements may be thought of as being “connected” or “coupled” to each other using at least one of the one or more wires, cables, and printed electrical connections and, as a number of non-limiting and non-inclusive examples, electromagnetic energy having wavelengths in the radio frequency region, the microwave region, and the light (both visible and invisible) region.

The reference signal may be abbreviated as RS or may be referred to as a pilot, depending on the applied standards.

The description “based on” used in the present specification does not mean “based on only” unless otherwise specifically noted. In other words, the phrase “based on” means both “based on only” and “based on at least”.

Any reference to an element using terms such as “first” or “second” as used in the present disclosure does not generally limit the amount or the order of those elements. These terms may be used in the present disclosure as a convenient way to distinguish between two or more elements. Therefore, references to the first and second elements do not imply that only two elements may be employed or that the first element must in some way precede the second element.

“Means” included in the configuration of each of the above apparatuses may be replaced by “parts”, “circuits”, “devices”, etc.

In the case where the terms “include”, “including” and variations thereof are used in the present disclosure, these terms are intended to be comprehensive in the same way as the term “comprising”. Further, the term “or” used in the present specification is not intended to be an “exclusive or”.

A radio frame may include one or more frames in the time domain. Each of the one or more frames in the time domain may be referred to as a subframe. The subframe may further include one or more slots in the time domain. The subframe may be a fixed length of time (e.g., 1 ms) independent from the numerology.

The numerology may be a communication parameter that is applied to at least one of the transmission and reception of a signal or channel. The numerology may indicate at least one of, for example, SubCarrier Spacing (SCS), bandwidth, symbol length, cyclic prefix length, transmission time interval (TTI), number of symbols per TTI, radio frame configuration, specific filtering processing performed by the transceiver in the frequency domain, and specific windowing processing performed by the transceiver in the time domain.

The slot may include one or more symbols in the time domain, such as OFDM (Orthogonal Frequency Division Multiplexing) symbols, SC-FDMA (Single Carrier Frequency Division Multiple Access) symbols, and the like. The slot may be a time unit based on the numerology.

The slot may include a plurality of mini slots. Each mini slot may include one or more symbols in the time domain. Further, the mini slot may be referred to as a sub-slot. The mini slot may include fewer symbols than the slot. PDSCH (or PUSCH) transmitted in time units greater than a mini slot may be referred to as PDSCH (or PUSCH) mapping type A. PDSCH (or PUSCH) transmitted using a mini slot may be referred to as PDSCH (or PUSCH) mapping type B.

A radio frame, a subframe, a slot, a mini slot and a symbol all represent time units for transmitting signals. Different terms may be used for referring to a radio frame, a subframe, a slot, a mini slot and a symbol, respectively.

For example, one subframe may be referred to as a transmission time interval (TTI), multiple consecutive subframes may be referred to as a TTI, and one slot or one mini slot may be referred to as a TTI. In other words, at least one of the subframe and the TTI may be a subframe (1 ms) in an existing LTE, a period shorter than 1 ms (e.g., 1-13 symbols), or a period longer than 1 ms. It should be noted that the unit representing the TTI may be referred to as a slot, a mini slot, or the like, rather than a subframe.

The TTI refers to, for example, the minimum time unit for scheduling in wireless communications. For example, in an LTE system, a base station schedules each terminal 20 to allocate radio resources (such as frequency bandwidth, transmission power, etc. that can be used in each terminal 20) in TTI units. The definition of TTI is not limited to the above.

The TTI may be a transmission time unit, such as a channel-encoded data packet (transport block), code block, codeword, or the like, or may be a processing unit, such as scheduling or link adaptation. It should be noted that, when a TTI is provided, the time interval (e.g., the number of symbols) during which the transport block, code block, codeword, or the like, is actually mapped may be shorter than the TTI.

It should be noted that, when one slot or one mini slot is referred to as a TTI, one or more TTIs (i.e., one or more slots or one or more mini slots) may be the minimum time unit for scheduling. Further, the number of slots (the number of mini slots) constituting the minimum time unit of the scheduling may be controlled.

A TTI having a time length of 1 ms may be referred to as a normal TTI (a TTI in LTE Rel. 8-12), a long TTI, a normal subframe, a long subframe, a slot, and the like. A TTI that is shorter than the normal TTI may be referred to as a shortened TTI, a short TTI, a partial TTI (or fractional TTI), a shortened subframe, a short subframe, a mini slot, a subslot, a slot, or the like.

It should be noted that the long TTI (e.g., normal TTI, subframe, etc.,) may be replaced with a TTI having a time length exceeding 1 ms, and the short TTI (e.g., shortened TTI, etc.,) may be replaced with a TTI having a TTI length less than the TTI length of the long TTI and a TTI length greater than 1 ms.

A resource block (RB) is a time domain and frequency domain resource allocation unit and may include one or more consecutive subcarriers in the frequency domain. The number of subcarriers included in an RB may be the same, regardless of the numerology, and may be 12, for example. The number of subcarriers included in an RB may be determined on the basis of numerology.

Further, the time domain of an RB may include one or more symbols, which may be 1 slot, 1 mini slot, 1 subframe, or 1 TTI in length. One TTI, one subframe, etc., may each include one or more resource blocks.

It should be noted that one or more RBs may be referred to as physical resource blocks (PRBs, Physical RBs), sub-carrier groups (SCGs), resource element groups (REGs), PRB pairs, RB pairs, and the like.

Further, a resource block may include one or more resource elements (RE). For example, 1 RE may be a radio resource area of one sub-carrier and one symbol.

The bandwidth part (BWP) (which may also be referred to as a partial bandwidth, etc.) may represent a subset of consecutive common RBs (common resource blocks) for a given numerology in a carrier. Here, a common RB may be identified by an index of RB relative to the common reference point of the carrier. A PRB may be defined in a BWP and may be numbered within the BWP.

BWP may include BWP for UL (UL BWP) and BWP for DL (DL BWP). For a UE, one or more BWPs may be configured in one carrier.

At least one of the configured BWPs may be activated, and the UE may assume that the UE will not transmit and receive signals/channels outside the activated BWP. It should be noted that the terms “cell” and “carrier” in this disclosure may be replaced by “BWP.”

Structures of a radio frame, a subframe, a slot, a mini slot, and a symbol described above are exemplary only. For example, the number of subframes included in a radio frame, the number of slots per subframe or radio frame, the number of mini slots included in a slot, the number of symbols and RBs included in a slot or mini slot, the number of subcarriers included in an RB, the number of symbols in a TTI, the symbol length, the cyclic prefix (CP) length, and the like, may be changed in various ways.

In the present disclosure, where an article is added by translation, for example “a”, “an”, and “the”, the disclosure may include that the noun following these articles is plural.

In this disclosure, the term “A and B are different” may mean “A and B are different from each other.” It should be noted that the term “A and B are different” may mean “A and B are different from C.” Terms such as “separated” or “combined” may be interpreted in the same way as the above-described “different”.

An aspect/embodiment described in the present specification may be used independently, may be used in combination, or may be used by switching according to operations. Further, notification (transmission/reporting) of predetermined information (e.g., notification (transmission/reporting) of “X”) is not limited to an explicit notification (transmission/reporting), and may be performed by an implicit notification (transmission/reporting) (e.g., by not performing notification (transmission/reporting) of the predetermined information).

As described above, the present invention has been described in detail. It is apparent to a person skilled in the art that the present invention is not limited to one or more embodiments of the present invention described in the present specification. Modifications, alternatives, replacements, etc., of the present invention may be possible without departing from the subject matter and the scope of the present invention defined by the descriptions of claims. Therefore, the descriptions of the present specification are for illustrative purposes only, and are not intended to be limitations to the present invention.

### DESCRIPTION OF THE REFERENCE NUMERALS

10 Base station
110 Transmission unit
120 Reception unit
130 Configuration unit
140 Control unit
20 Terminal
210 Transmission unit
220 Reception unit
230 Configuration unit
240 Control unit
1001 Processor
1002 Storage device
1003 Auxiliary storage device
1004 Communication device
1005 Input device
1006 Output device

1. A base station comprising:
a reception unit configured to perform time division multiplexing of a plurality of reception beams corresponding to a plurality of transmission beams applied for transmission in COT (Channel Occupancy Time), and to perform LBT (Listen before talk) in which sensing is performed by applying each of the plurality of reception beams; and
a transmission unit configured to apply, to the transmission in the COT, a transmission beam corresponding to a reception beam, among the plurality of the reception beams, for which a busy state is not detected in the LBT.

2. The base station as claimed in claim 1, wherein
The reception unit performs sensing by applying each of the plurality of reception beams according to an order of reception beams corresponding to an order of transmission beams applied in the COT.

3. The base station as claimed in claim 1, wherein
the reception unit performs LBT by applying an omnidirectional beam or performs LBT by applying a wider reception beam in a case where the busy state is detected in a sensing by applying one reception beam among the plurality of reception beams in the LBT.

4. The base station as claimed in claim 1, wherein
the reception unit continues sensing by applying the reception beam for which the busy state is detected until the busy state is cleared in a case where the busy state is detected in a sensing by applying one reception beam among the plurality of reception beams in the LBT.

5. The base station as claimed in claim 1, wherein
the reception unit configures an upper limit to a number of reception beams applied to the sensing, and, in a case where a number of the plurality of reception beams exceeds the upper limit, the reception unit performs the sensing by applying reception beams within the upper limit: by not applying some of the plurality of reception beams: or by performing the sensing by not applying some of the plurality of reception beams and by using a wider reception beam that include s reception beams that are not applied to the sensing.

6. A communication method performed by a base station, the communication method comprising:
performing time division multiplexing of a plurality of reception beams corresponding to a plurality of transmission beams applied for transmission in COT (Channel Occupancy Time), and performing LBT (Listen before talk) in which sensing is performed by applying each of the plurality of reception beams; and
applying, to the transmission in the COT, a transmission beam corresponding to a reception beam, among the plurality of the reception beams, for which a busy state is not detected in the LBT.
